(19) United States
(12) Patent Application Publication
(10) Pub. No.: US 2016/0053539 A1
(43) Pub. Date: Feb. 25, 2016

(54) LADDER STABILIZER

(71) Applicants: Raymond Hopkins, Uxbridge (CA); Peter Stapleton, Richmond Hill (CA)

(72) Inventors: Raymond Hopkins, Uxbridge (CA); Peter Stapleton, Richmond Hill (CA)

(21) Appl. No.: 14/842,103

(22) Filed: Sep. 1, 2015

Related U.S. Application Data
(63) Continuation of application No. 13/367,772, filed on Feb. 7, 2012, now abandoned.
(60) Provisional application No. 61/440,007, filed on Feb. 7, 2011.

(51) Int. Cl. E06C 7/46; E06C 7/42

(52) U.S. Cl. CPC E06C 7/46; E06C 7/42

(57) ABSTRACT

A ladder stabilizer having a base plate that engages with a lower portion of the ladder and having a tire receiving portion at an end portion of the base plate. The weight of a vehicle tire on the tire receiving portion provides increased stability to the base plate of the ladder stabilizer. The tire receiving portion can be moved to either side of the base plate and can have a base plate-engaging mechanism on its bottom surface to couple with a mating surface of the base plate. The ladder can be retained by a leg retainer, rung retainer, or other retaining member that is coupled to a ladder retainer attachment portion of the base plate. Preferably, the ladder retainer mechanism includes some type of fastener or tensioning mechanism to secure the lower portion of the ladder to the base plate.

### CROSS-REFERENCE TO RELATED APPLICATIONS

This application claims the benefit of U.S. Provisional No. 61/440,007, filed Feb. 7, 2011.

### FIELD OF THE INVENTION

The present application relates generally to ladders. More specifically, the present application relates to a ladder stabilizer.

### BACKGROUND OF THE INVENTION

Extension ladders are well known in the art. Because extension ladders are supported on the ground or other support surface at one end, stability issues arise especially when the extension ladders are extended to significant lengths. As a result, when a person climbs an extension ladder it is desirable to have another person or some other form of stability support to prevent the ladder from sliding or rocking and thus avoiding placing the climber in danger.

Many devices to support or stabilize extension ladders have been considered. For example, U.S. Pat. No. 6,629,582 to Barnett describes an extension ladder having an anti-slide device which ensures proper ladder inclination angles to help prevent slide-out of the base when a person climbs the ladder.

U.S. Pat. No. 6,412,599 to Thompson et al. describes an extension ladder with a load-dispersing device for leaning against the gutter of a house. The load-dispersing device helps prevent damage to the gutter and reduces horizontal slippage of the ladder.

U.S. Pat. No. 7,134,525 to Ferris and U.S. Pat. No. 7,380,640 to Kemp et al. describe extension ladders having chains or clamps that secure a ladder to a protrusion such as the gutter on the roof of a house.

U.S. Pat. No. 6,065,566 to Brown et al., U.S. Pat. No. 6,527,084 to Hrincu, U.S. Pat. No. 6,851,518 to Walker, U.S. Pat. No. 7,163,084 to Blehm, U.S. Pat. No. 7,216,742 to Spengler, U.S. Patent Application Publication No. 2007/0000725 to Bell, and U.S. Patent Application Publication No. 2008/0000721 to Deal describe extension ladders with struts that act as extra supporting legs to help prevent rocking or sideways sliding of the ladders.

U.S. Pat. No. 6,357,548 to Boyd describes an extension ladder support device that attaches to a towing hitch of a vehicle, such that the ladder can be transported in a horizontal position and deployed in a vertical position. The ladder support device includes safety brackets that limit the range of motion of the extended ladder, thus preventing rocking or sliding.

Although methods and devices to support or stabilize ladders exist, improvements are desired.

### SUMMARY

According to one aspect, a ladder stabilizer is provided comprising a base plate that engages a lower portion of a ladder and a tire receiving portion on the base plate to receive a tire from a vehicle to stabilize the base plate and coupled ladder. Preferably, the tire-receiving portion is moveable to either end portions of the base plate. The bottom surface of the tire-receiving portion can have a base plate-engaging mechanism to fixedly coupled the tire receiving portion to the base plate, such as protrusions that engage apertures in the base plate. In a further aspect, the base plate has a ladder retainer attachment portion to a receive ladder retaining member that couples the ladder to the ladder retainer attachment portion of the base plate. Preferable, the ladder retaining member includes a tensioning mechanism that can include any one of a ratcheting tie down, a spring clamp, a cam fastener, buckle, over-center fastener and a ratcheting fastener. In some aspects, the base plate defines an aperture for receiving ground affixing fasteners to attach the base plate to a supporting surface.

According to another aspect, a ladder stabilizer is provided comprising a base plate with a tire receiving portion and a leg retainer mounted thereon for engaging a ladder leg. The leg retainers can be pivotably and/or slidably mounted about a shaft on the base plate. The leg retainer can define a channel for receiving the ladder leg, preferably, the leg retainer is adjustable to alter a dimension of the channel. In a related aspect, the tire receiving portion can have a formation on the base plate for positioning the tire, such as a well.

Other features and advantages of the present invention will become apparent from the following detailed description. It should be understood, however, that the detailed description, while indicating embodiments of the invention, is given by way of illustration only, since various changes and modifications within scope of the invention will become apparent to those skilled in the art from said detailed description.

### BRIEF DESCRIPTION OF THE DRAWINGS

Embodiments will now be described with reference to the accompanying drawings, in which:

FIG. 1 is a perspective view of one embodiment of a ladder stabilizer, showing leg retainers of the ladder stabilizer engaging legs of an extended ladder;

FIG. 2 is a perspective view of the ladder stabilizer shown in FIG. 1 with the leg retainers in a vertical position without an engaged ladder;

FIG. 3A is a top plan view of the ladder stabilizer shown in FIG. 2 with the leg retainers in a horizontal position;

FIG. 3B is a front elevation view of the ladder stabilizer shown in FIG. 3A;

FIG. 4A is side elevation view of the leg retainer of the ladder stabilizer shown in FIG. 3A, shown in isolation;

FIG. 4B is top plan view of the leg retainer shown in FIG. 4A;

FIG. 4C is a sectional of the leg retainer shown in FIG. 4A, taken through section C-C of FIG. 4A;

FIG. 5A is a perspective view of one end of the leg retainer shown in FIG. 4A;

FIG. 5B is a sectional view of the leg retainer shown in FIG. 5A, taken through section B-B of FIG. 5A;

FIG. 6 is a perspective view of another embodiment of a ladder stabilizer, showing a rung retainer of the ladder stabilizer engaging a rung of a ladder;

FIG. 7 is a perspective view of an alternative embodiment of a ladder stabilizer having a movable tire receiving portion.

### DETAILED DESCRIPTION OF VARIOUS EMBODIMENTS

A ladder stabilizer comprising a base plate having at least one tire-receiving portion and a ladder retainer coupled to the base plate for engaging a lower portion of the ladder is described herein. The ladder stabilizer can aid in preventing any one of the following: “sliding out” of an extension ladder, wherein the bottom feet of the ladder slide away from a building or other structure supporting the ladder; “sliding sideways”, wherein the top of the ladder slides sideways along a roof top or wall; “rocking”, wherein the ladder tilts from side to side as a user ascends or descends the ladder; “pulling away”, wherein the top of the ladder moves away from the wall or roof that the upper portion of ladder is resting upon when the user stands on or ascends the ladder; and “sinking”, wherein the feet of the ladder sink into the ground or other support structure, particularly ground comprising soft pavement, soil, gravel, mud, and so on. The ladder stabilizer can also aid in improving ladder foot anchorage by reducing the pounds per square inch (PSI) force on the ground.

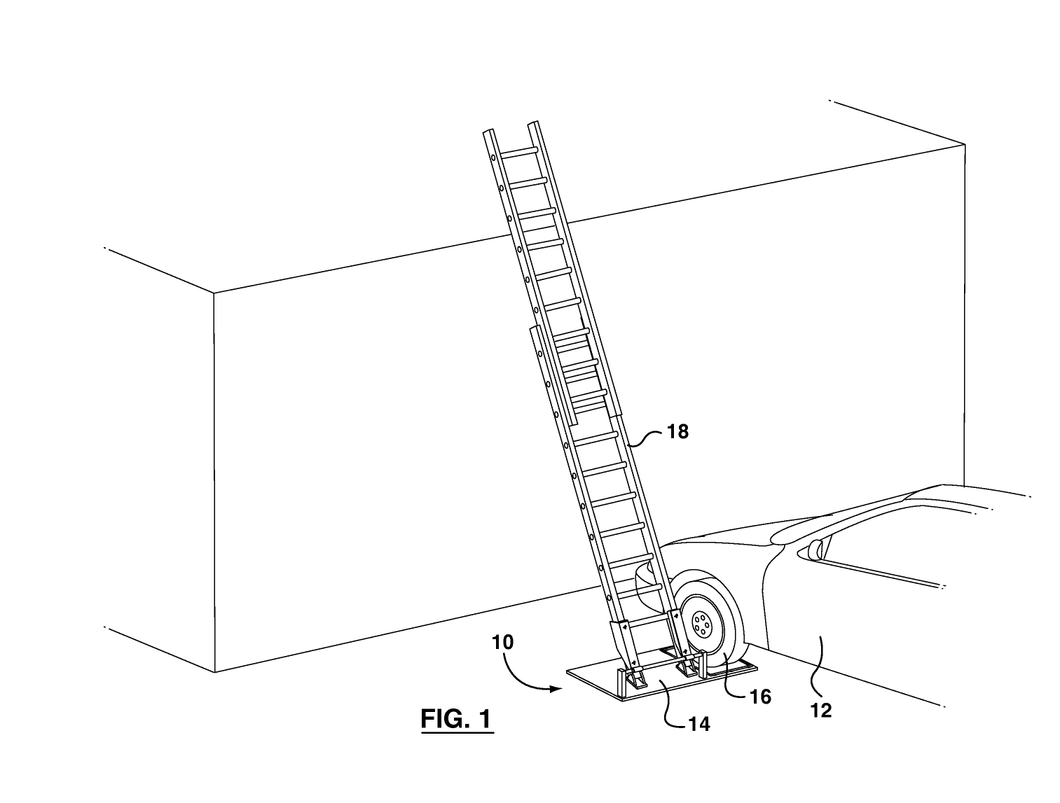

Turning now to FIGS. 1 to 5, a first embodiment of the ladder stabilizer will be described. As can been seen, a ladder stabilizer 10 is shown in combination with a ladder 18 in FIG. 1. A vehicle 12 is positioned relative to a base plate 14 of the ladder stabilizer 10 so that at least one tire 16 of the vehicle is positioned on top of the base plate 14. The ladder 18 is retained in position by the ladder stabilizer 10.

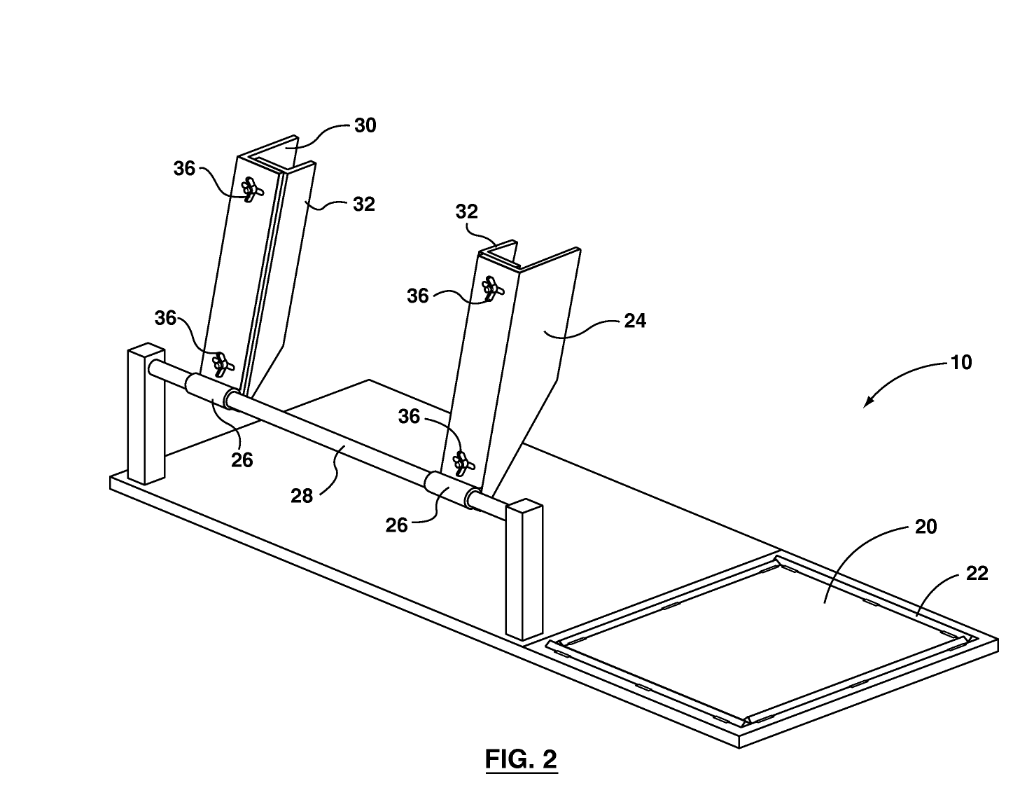

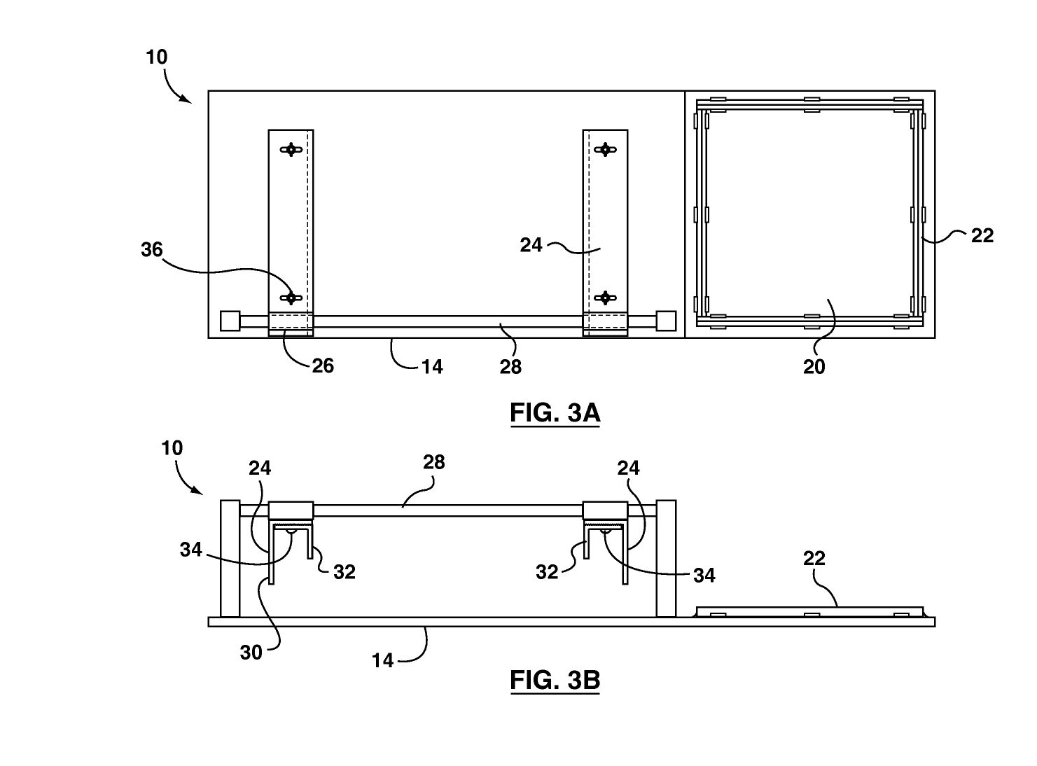

A closer view of the ladder stabilizer 10 is shown in FIGS. 2, 3A, and 3B. The base plate 14 has a tire-receiving portion 20. The tire-receiving portion 20 is sized to accommodate at least a part of the tire 16 of the vehicle 12. The tire-receiving portion 20 may be provided with one or more walls 22 around its perimeter, which aid in positioning the tire 16 on the tire-receiving portion 20. Tire receiving portion 20 can be integral with base plate 14 or a separate element coupled to base plate 14.

A shaft 28 is attached to the base plate 14 by any means known, such as welding, rivets, screws, and so on. The shaft 28 has a central portion that is placed substantially parallel to the rungs of the ladder 18. There are leg retainers 24 disposed upon the shaft 28 that engage the legs of the ladder 18. In the illustrated embodiment, each leg retainer 24 carries a rotary bearing 26 through which the shaft 28 passes. Each rotary bearing 26 allows each leg retainer 24 to pivot around the shaft 28. The rotary bearing 26 can be attached to the leg retainer 24 by any known means, such as welding, rivets, screws, and so on. The leg retainers 24 are laterally spaced from the tire-receiving portion 20, so as to not interfere with the positioning of the tire 16 thereon.

Each rotary bearing 26 at least partially surrounds the shaft 28, thus allowing the leg retainers 24 to independently pivot around the shaft 28 in the direction in which the ladder leans. Further, each rotary bearing 26 allows the leg retainers 24 to slide along the length of the shaft 28 laterally in relation to the longitudinal axis of the ladder. Each rotary bearing 26 can each be provided with a bushing to facilitate pivoting and sliding movements. Thus, in the illustrated embodiment, the leg retainers 24 can pivot to an angle that would match the desired lean of the ladder 18. Additionally, sliding the leg retainers 24 along the shaft 28 allows the ladder stabilizer 10 to accommodate various ladders 18 having legs that are different distances apart.

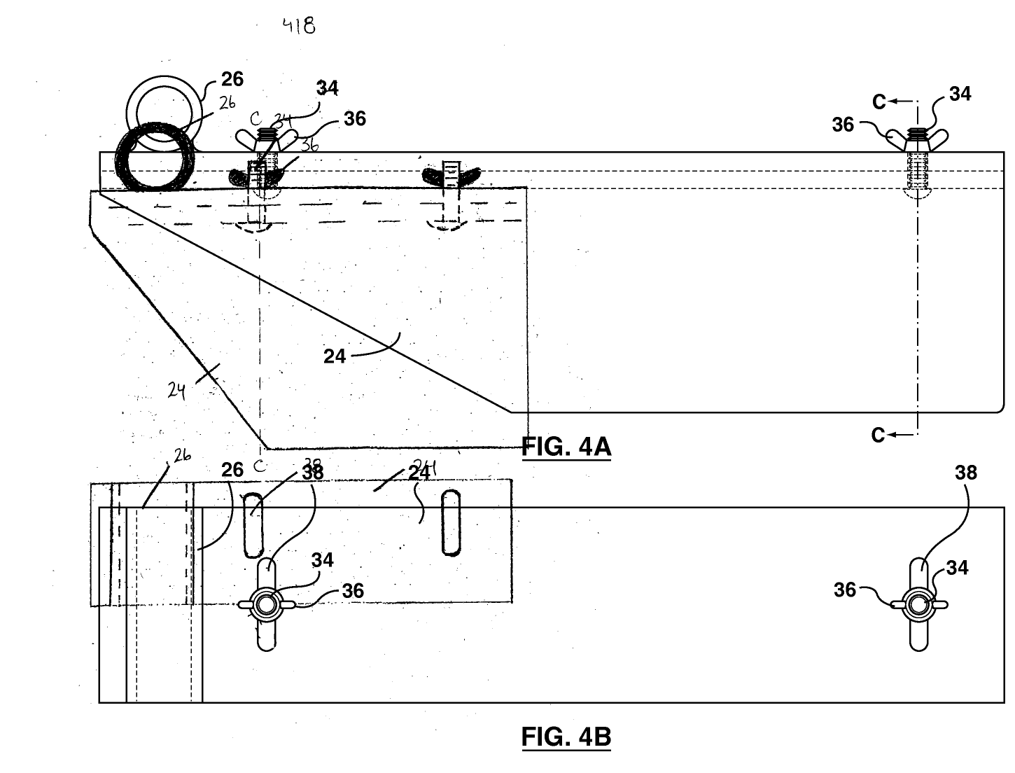

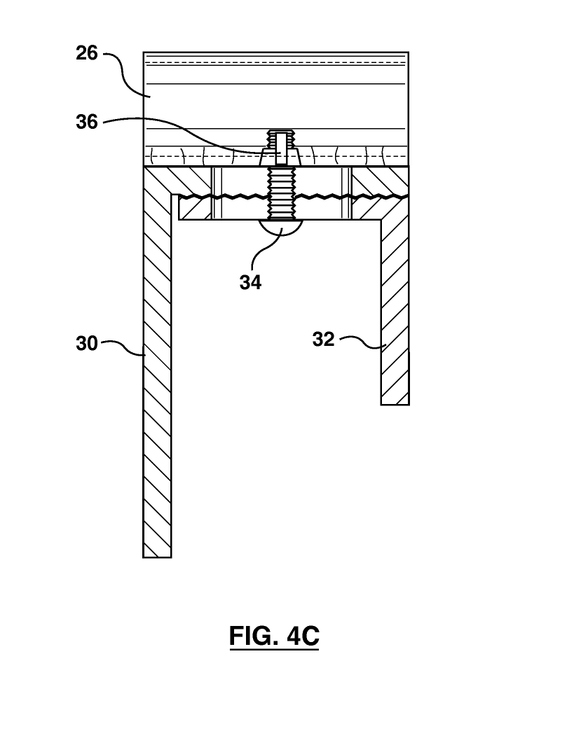

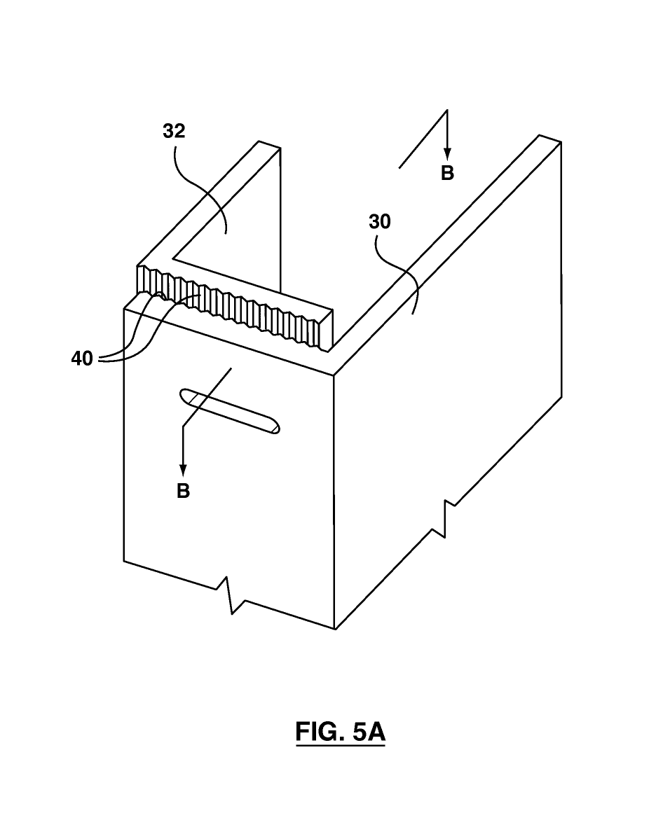

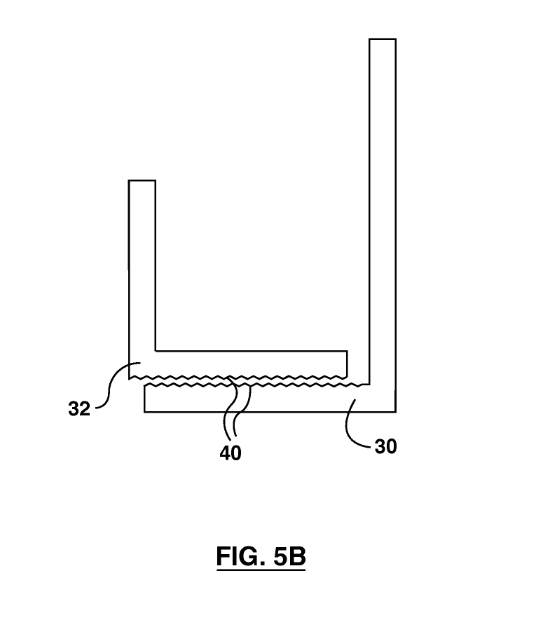

Referring now to FIGS. 4A, 4B, 4C, 5A, and 5B, one leg retainer 24 is shown in isolation. As can be seen, each leg retainer 24 is provided with one adjustable part so that the leg retainer 24 can be opened to accommodate easily a ladder leg and then closed to clamp the ladder leg in place. Each leg retainer 24 forms a channel, the walls of which surround the leg of the ladder 18 on three sides. The adjustable part also allows the leg retainer 24 to be adjusted so as to alter the dimension of the channel and thus accommodate ladder legs having different widths and rung heights. Each leg retainer 24 may be formed from two separate cooperating members 30 and 32 that are attached together by a releasable fastener, such as, for example, a bolt 34 and wingnut 36. One or both of the cooperating members 30 and 32 are provided with a slot 38 through which the bolt 34 fits. In this embodiment, the length of the slot 38 determines the distance along which the leg retainers 24 can be extended. As is shown in FIGS. 5A and 5B, the facing sides of the cooperating members 30 and 32 may be provided with ridges and indents 40 that register with each other. The ridges and indents 40 aid in locking the leg retainers 24 in the clamped position around the leg of the ladder 18 and also ensure that the cooperating members 30 and 32 remain parallel to one another and thus flush with the leg of the ladder 18.

In use, the ladder stabilizer 10 is placed in the desired location. It will be evident that the small size of the ladder stabilizer 10 allows a single individual to operate the ladder stabilizer 10 with relative ease. Once the ladder stabilizer 10 is in approximately the desired location, the person can raise and lean the ladder 18 against a structure with the legs of the ladder 18 on the base plate 14 of the ladder stabilizer 10 in proximity to each leg retainer 24. Alternatively, the ladder 18 could be raised first and then the ladder stabilizer 10 could be slid underneath the legs of the ladder 18, or the feet of ladder 18 can be placed on the base plate 14. Ladder 18 can be lifted in order to place the ladder feet onto the base plate 14 of the ladder stabilizer 10. Once the ladder 18 and the ladder stabilizer 10 are in the desired position, each leg retainer 24 is pivoted and adjusted individually by separating or bringing together the cooperating members 30 and 32, and in relation to one another by sliding each rotary bearing 26 along the shaft 28. In this way, each leg retainer 24 can receive a respective leg of the ladder 18. The cooperating members 30 and 32 can then be adjusted inwards and secured with the bolt 34 and wingnut 36 so as to clamp around the legs of the ladder 18, thus securing it in place. Once the ladder 18 is secured and positioned as desired, the vehicle 12 can be positioned so that one tire 16 is located on the tire-receiving portion 20 of the base plate 14. In this way, the ladder 18 is ready for use and the person can climb up and down the ladder 18 with increased stability to reduce movement, rocking or sliding. An acceptable ladder lean angle would be known to a skilled person, and typical industry standards fall within the range of 3:1 to 4:1 (vertical:horizontal).

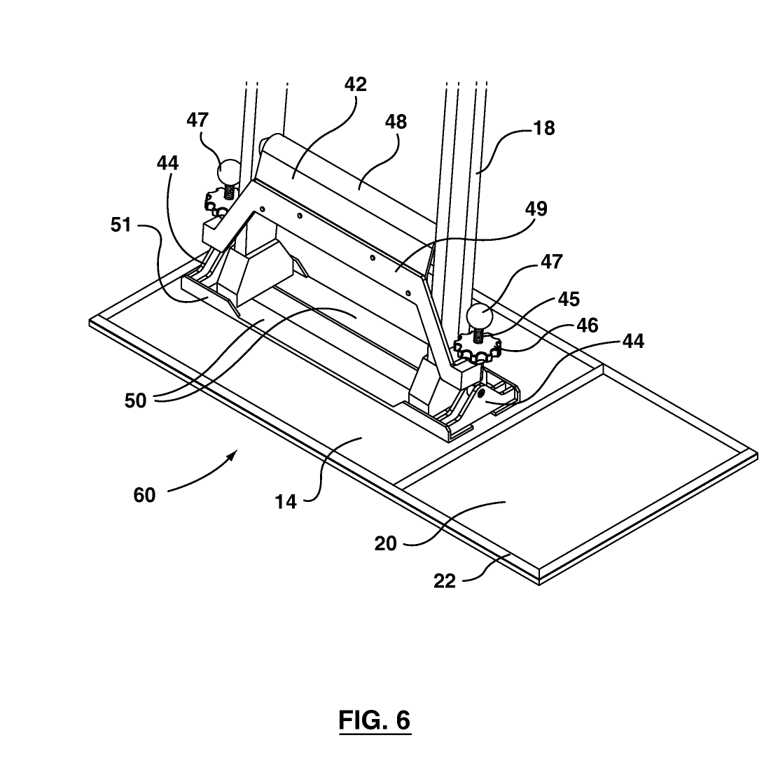

Another embodiment of the ladder stabilizer 60 will now be described in reference to FIG. 6. Similar to the previous embodiment, the base plate 14 comprises a tire-receiving portion 20 with walls 22 around its perimeter. A pair of brackets 50 is mounted on the base plate 14. Each of the brackets 50 has an upstanding portion 51 at each end, such that there are two pairs of upstanding portions 51, one pair located near each end of the pair of brackets 50. The pairs of upstanding portions 51 are spaced sufficiently apart such that the legs of a ladder 18 will fit between the members of each pair of upstanding portions 51, one leg being disposed near each end of the brackets 50.

A pair of arms 44 is mounted between the pairs of upstanding portions 51. Each member of the pair of arms 44 is located near one end of the pair of brackets 50 and the upstanding portions 51 may assist in holding the arms 44 in place. The arms 44 are spaced apart from one another so that the legs of the ladder will fit in between the pair of arms 44. The arms 44 and the upstanding portions 51 of the brackets 50 will cooperate to reduce lateral sliding of the ladder 18. Alternative embodiments can include arms 44 interior to the legs of the ladder, and in some embodiments, can include a single arm for pivotably attaching a rung retainer 42.

Each of the arms 44 includes a releasable fastener, such as, for example, a screw 45 and nut 46 combination. The screw 45 is pivotally attached to the arm 44 at one end and has a ball 47 at the other end to prevent the nut 46 from being completely released from the screw 45. The pivotal attachment of the screw 45 to the arm 44 allows the screw 45 and nut 46 combination to pivot in the direction of lean of the ladder 18. The nut 46 may be twisted around the screw 45 and thereby be moved closer or further away from the arm 44.

A rung retainer 42 extends between the pair of arms 44 and is mounted to the screw 45 found on each of the arms 44. The rung retainer 42 has a longitudinal portion 49 that extends between the arms 44. Each end of the longitudinal portion is mounted to a respective screw 45 above the arm 44 and below the nut 46. The rung retainer 42 also has a lip 48 that wraps at least in part around a ladder rung. When the nut 46 is screwed toward the arm 44, it pushes the rung retainer 42 down to engage the ladder rung. When the nut 46 is screwed away from the arm 44, the rung retainer 42 can be raised to release the ladder rung. Since the screw 45 is itself pivotal, the rung retainer 42 is also pivotal. Due to this, the lean of the ladder 18 can be adjusted even once the ladder 18 is in place on the ladder stabilizer 60 and the lip 48 is engaging the ladder rung.

In use, the ladder stabilizer 60 is placed in the desired location and the ladder 18 is raised and leaned against a structure with the legs of the ladder 18 on the base plate 14 of the ladder stabilizer 60 in between each of the arms 44. Alternatively, the ladder 18 could be raised first and then the ladder stabilizer 60 could be slid underneath the legs of the ladder 18, or the ladder feet can otherwise be placed upon the ladder stabilizer. Ladder 18 can be lifted and placed onto the base plate 14 of the ladder stabilizer 60. Once the ladder 18 and the ladder stabilizer 60 are in the desired position, the lip 48 of the rung retainer 42 is placed over the lowermost ladder rung. The rung retainer 42 is then secured over the ladder rung by tightening the nut 46, thus securing the ladder in position. Once the ladder 18 is secured and positioned as desired, the vehicle 12 can be positioned so that one tire 16 is located on the tire-receiving portion 20 of the base plate 14.

As will be appreciated, the ladder stabilizer described herein is easy for a single person to use and transport and secures the ladder 18 so that a person can climb the ladder 18 with increased stability to reduce movement, rocking or sliding of ladder 18. Furthermore, the small size of the ladder stabilizer also allows the individual to transport the ladder stabilizer in the trunk of a car or the back of a pick-up truck or van, as desired.

The base plate 14 may be fabricated from any type of material or combination of materials known to a skilled person, such as wood, plastic, or metal. In some aspects, the base plate 14 is metal. It is also contemplated that the base plate 14 could be provided in part or in entirety with a friction-enhancing surface on the top and/or bottom, such as ridges and wells, a rough sand-paper coating, or a rubber coating, for example. Although the base plate 14 is illustrated as being rectangular, it should be understood that it could be formed in any shape, such as circular, triangular, polygonal, or irregular, for example, as long as it provides at least one tire-receiving portion 20 and at least one leg retainer 24.

Furthermore, as illustrated, the tire-receiving portion 20 could be sized to fit a standard vehicle tire 16, such as that found on a truck or a van. However, the tire-receiving portion 20 could be adapted to receive a tire 16 that is small, such as that found on an all-terrain vehicle or a forklift, or very large, such as that found on a tractor or vehicles used in construction. Thus, the ladder stabilizer may be used in combination with a heavy vehicle 12, such as a car or a truck. In other aspects, a lighter two- or three-wheeled vehicle 12 such as a motorcycle may be of sufficient weight to stabilize a ladder 18 that is clamped to the ladder stabilizer.

The tire-receiving portion 20 has been illustrated and described as having at least one wall 22 around its perimeter. It is also contemplated that the tire-receiving portion 20 could be instead provided with any type of formation for positioning the tire 16 such as, for example, a well or a well together with one or more walls 22. In other embodiments, the tire-receiving portion 20 could simply be an extension of the base plate 14 and could thus lack both walls 22 and a well. Furthermore, the base plate 14 can be provided with more than one tire-receiving portion 20, or a moveable tire receiving portion that can be coupled to either side of the base plate 14. For example, it may be desired in some instances to have the option of driving on either side of the ladder 18, or to have two vehicles in use at once to stabilize a particularly long ladder 18. In other aspects, the tire-receiving portion 20 may be sufficiently large so as to accommodate more than one tire 16 of a single vehicle 12. It is also within the scope of this invention to provide the tire-receiving portion 20 in any area around the leg retainers 24, not just to one side of the leg retainers 24, as is illustrated in the figures. It is also possible that the tire-receiving portion 20 could be provided as a removable section. Further, the tire-receiving portion 20 could be attached to the base plate 14 by hinges, pins, or other means of attachment known to a skilled person.

It is contemplated that the ladder stabilizer could be fastened directly to the ground or other support surface via one or more ground-securing elements such as, for example, suction cups or stakes. In such embodiments, the tire-receiving portion 20 would be optional. For example, the base plate 14 could be provided with suction cups attached to the bottom or one or more sides of the base plate 14 for gripping concrete or other relatively smooth surfaces. In other embodiments, the base plate 14 could have apertures for driving one or more stakes therethrough, such that the stakes would secure the ladder stabilizer to the ground. Further, a friction-enhancing or non-slip surface provided on the ground-contacting surface of the base plate 14 may also be sufficient on its own to stabilize certain ladders. Any of these embodiments could be used alone, in combination with one another, and/or in combination with a tire-receiving portion.

The ladder stabilizer 10 has been illustrated in one aspect as having two leg retainers 24, however, it is understood that in some cases a single leg retainer 24 may provide sufficient stability to a ladder 18 to reduce movement, rocking or sliding. The leg retainers 24 can be attached to the shaft 28 so as to pivot around the shaft 28, or they can be stationary and thus fabricated at a predetermined angle that would match a typical ladder lean angle. It is also contemplated that the leg retainers 24 could be attached together so as to pivot as one unit. Similarly, the leg retainers 24 could be attached together so as to slide as one unit.

It is also possible to provide the leg retainers 24 a standard width apart, so as to accommodate most standard-sized ladders 18. Thus, the leg retainers 24 could be attached to the shaft 28 so as to pivot and not slide, so as to slide and not pivot, or to neither pivot nor slide. It is also contemplated that a shaft 28 may not be required for attachment in all cases. For example, the leg retainers 24 could be attached directly to the base plate 14. In this embodiment, the leg retainers 24 could be attached so as to not move, or they could be attached by means of a hinge to allow the leg retainers 24 to pivot in the direction of the lean of the ladder 18. In embodiments of the ladder stabilizer 10 using a shaft 28, it is understood that the shaft 28 could be integral with the base plate 14 or it could be a separate piece attached to the base plate 14 by any means known. The shaft 28 can be fabricated from metal, plastic, wood, or any other material or combination of materials known to a skilled person.

In the illustrated embodiment, one side of each leg retainer 24 is adjustable and each leg retainer 24 surrounds a leg of the ladder 18 on three sides. However, any side of the leg retainers 24 could be adapted to be adjustable, and furthermore, the leg retainers 24 could be provided with one, two, or four sides, rather than three, so long as a leg of a ladder 18 could be secured in place with any form of adjustable restraint known to a skilled person. The cooperating sides 30 and 32 are held in place by registering ridges and indents 40, which is an optional feature. The use of a slot 38 and a bolt 34 and wingnut 36 to hold the cooperating members 30 and 32 in place could also be substituted by other means known to a skilled person. For example, a variety of spaced holes and a pin could be used instead. In other embodiments, the securing can be achieved by means other than clamping. For example, a leg could be secured to a leg retainer 24 by a strap, a vise, or Velcro™, for example. Furthermore, the leg retainer 24 itself could be formed as a slot into which the leg of a ladder 18 slides. In this case no additional securing means would be necessary.

The rung retainer has been described above as having arms 44 that are disposed on brackets 50 on the base plate 14 so as to support the outside portions of the ladder legs. It will be understood, however, that the arms 44 could be disposed on the brackets 50 so as to support the inside portions of the ladder legs. Furthermore, two arms 44 are not required, as only a single arm would suffice to support a ladder 18. It will also be understood that the brackets 50 are optional features and act to provide additional support to the ladder 18. As has been described above for the leg retainers 24, it will be understood that the arms 44 could be slidable along the base plate 14 and independently pivotal or stationary. The rung retainer 42 could be provided in two separate portions, each of which attaches to a respective arm 44 and surrounds the ladder rung. In this way, the arms 44 and rung retainer 42 portions could be slidable along the base plate 14 to accommodate different sized ladders.

It is another aspect to provide a ladder comprising the ladder stabilizer 10 described above. In this embodiment, the ladder and the ladder stabilizer 10 could be fabricated as a single item. As described above, the leg retainers 24 or screws 45 could pivot so as to achieve the desired ladder lean, or they could be stationary to achieve a predetermined ladder lean angle. However in this embodiment, the ladder 18 would already be attached to the ladder stabilizer 10. It is also possible that leg retainers 24 or a rung retainer 42 would not be required and a ladder 18 could simply be fabricated with a base plate 14 attached thereto. A user would place the ladder/ladder stabilizer combination where desired and would then drive a vehicle 12 onto the tire-receiving portion 20 of the base plate 14 to secure the ladder 18 in place and prevent rocking or sliding.

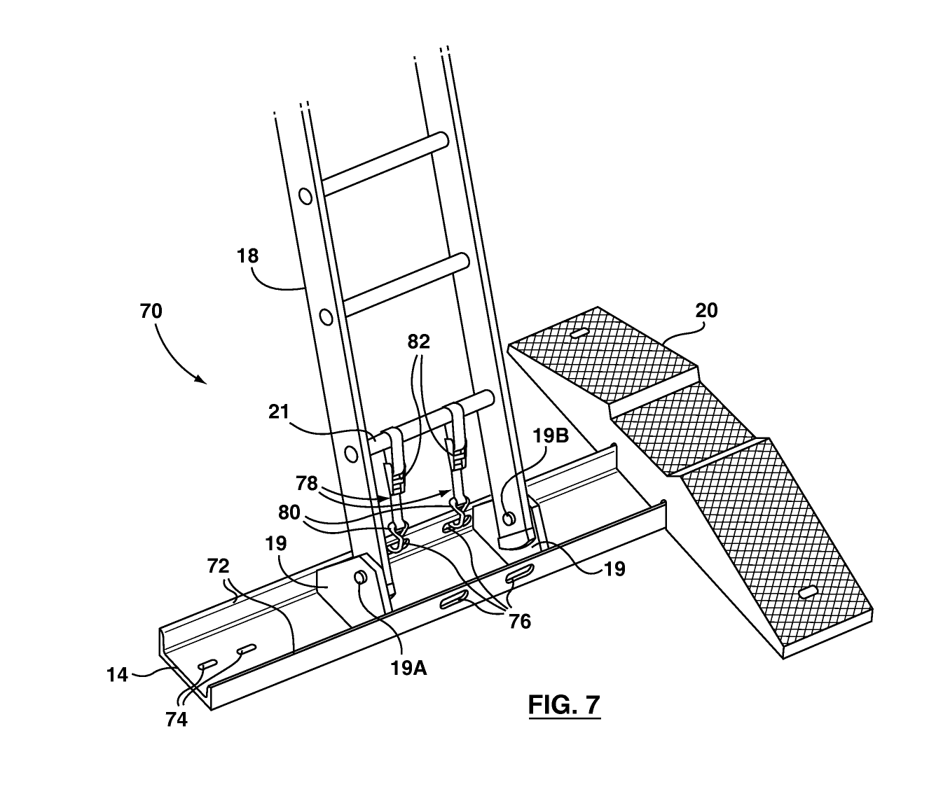

Referring now to FIG. 7, a perspective view is shown of an alternative embodiment of a ladder stabilizer 70 having a movable tire receiving portion 20 coupled to the base plate 14. The tire receiving portion 20 is sized to accommodate at least part of the tire 16 of the vehicle 12. The tire receiving portion 20 is a removable section that can be placed on either end portion of the base plate 14 to transfer weight from the tire 16 to the base plate 14 to provide stability to the ladder stabilizer 70.

The base plate 14 can have two upstanding portions 72 that form a ladder foot-receiving channel with the upper surface of the base plate 14 and between the inner surfaces of the upstanding portions 72. The upstanding portions 72 can be at the edge of base plate 14 (as in FIG. 7), or if the base plate 14 is larger, anywhere on the base plate 14 to form the ladder foot-receiving channel.

The ladder feet 19 of the ladder 18 can be placed into the ladder-foot receiving channel to assist in stabilizing movement of the ladder 18. The ladder 18 has ladder-foot pivots 19A and 196 that allows the ladder 18 to pivot or otherwise adjust the angle of the ladder 18 while placed in the ladder foot-receiving channel. The width of the ladder foot-receiving channel can be sized to accommodate most commercially available ladders.

In alternative embodiments of the ladder stabilizer 70, the width of the ladder foot-receiving channel can be adjustable to accommodate different ladder foot sizes. At least one of the upstanding portions 72 can be adjustable on the base plate 14 to allow for an adjustable width ladder foot-receiving channel. In some embodiments, the adjustable ladder foot-receiving channel can also be adjusted to apply a compressive force to the ladder feet to fixedly coupled the ladder feet to the base plate 14 to aid in stabilizing the ladder 18.

Other embodiments of the ladder stabilizer can have a single upstanding portion 72 that is used to prevent the ladder from “sliding out”. The single upstanding portion 72 extends from the base plate 14 on the side that makes an obtuse angle between the ground and the leaning ladder 18.

The ladder foot-receiving channel can also have an upward projection at each end that interferes with the bottom surface of the tire receiving portion 20 when the tire receiving portion 20 is not placed completely on the base plate 14. The upward projection can be a continuation of upstanding portions 72 to surround the base plate 14. The ladder foot-receiving channel can also have inward or outward projections from one or both of the upstanding portions 72 that engages with the bottom surface of the tire receiving portion 20 to assist aligning the tire receiving portion 20 and/or to limit the positions that the tire receiving portion 20 can be placed along the base plate 14.

The bottom surface of the tire receiving portion 20 can have a base plate-engaging mechanism to mate with the base plate 14. For example, the bottom surface can have grooves that mate with the upstanding portions 72 to assist in positioning the tire receiving portion 20 on the base plate 14. The bottom surface of the tire receiving portion 20 can also have protrusions that engage with an indentation or aperture in the base plate 14, or vice-versa, with the base plate 14 having protrusions that engage with indentations in the lower surface of the tire receiving portion 20.

The tire receiving portion 20 can have a ramp on each end to facilitate positioning the tire 16 of the vehicle 12 on the tire receiving portion 20. The upper surface of the tire receiving portion 20 can be textured or have a friction promoting surface to provide traction for the tire 16. A middle portion of the tire receiving portion 20 can have a slight indentation that assists to position the tire 16 of the vehicle 12 onto the tire receiving portion 20. The slight indentation can provide feedback to the driver of the vehicle 12 to let them know that the tire 16 is properly positioned with respect to the tire receiving portion 20.

The tire receiving portion 20 can be composed of rubber, plastic or other materials known to a person skilled in the art. The material can be reinforced with a metal or the lower surface of the tire receiving portion 20 can be composed of a metal plate. Preferably, the tire receiving portion 20 is composed of a light weight material to allow it to be easily moved from either side of the base plate 14 or transported between work sites. Alternatively, more rigid material can be used while allowing some inner portions to remain hollow (e.g. a honey comb structure). The tire receiving portion 20 can also have an attached handle (e.g. a rope handle on lateral surfaces) or an integral handle (e.g. in the bottom or lateral surfaces of tire receiving portion 20) to facilitate handling.

The base plate 14 can have one or more apertures 74 defined therein for receiving ground affixing fasteners that secure the base plate 14 to the ground or other support surface. For example, stakes can be driven into the ground through the apertures 74 in order to secure the ladder stabilizer 70 to the ground. Other ground affixing fasteners can be used depending on support surface material. For example, nails can be used if the ladder stabilizer 70 is placed on an unfinished wooden floor. Ground affixing fasteners can be used, in combination with or without, the tire receiving portion 20 to provide stabilization to the base plate 14. The apertures can be on both end portions of the base plate 14, and can also serve to engage protrusions on bottom surface of the tire receiving portion 20 to position the tire receiving portion 20 on the base plate 14.

The base plate 14 can have one or more ladder retainer attachment portions 76 that receive ladder retaining members 78. The ladder retainer attachment portions 76 provide a mechanism to allow the ladder retaining members 78 to attach the ladder 18 to the base plate 14 to provide further stabilization. The ladder retainer attachment portions 76 can be defined as apertures in any one of the at least two upstanding portions 72 as illustrated in FIG. 7. Having apertures in both upstanding portions 72 allows for more flexibility in positioning the ladder stabilizer 70. The apertures can be smoothed or include protective grommet to avoid damaging ladder retaining members 78. The ladder retainer attachment portions 76 can also be implemented as an anchor or a hook that is attached to the base plate 14 or upstanding portions 72. For example, a bolt with an anchor or hook head can be attached to the upstanding portions 72.

The ladder retainer attachment portions 76 are illustrated in a position between the feet 19 of the ladder 18 in FIG. 7. In other embodiments, the ladder retainer attachment portions 76 can be positioned outside of the area between the feet 19. This can allow ladder retaining members 78 to be coupled to the outer ladder retainer attachment portions 76 to provide lateral force on the lower portion of ladder 18 to provide further lateral stability to the ladder 18.

At least one ladder retaining member 78 couples a lower portion of the ladder 18 to one of the ladder retainer attachment portions 76 of the base plate 14. Since the base plate 14 is stabilized by weight upon the tire receiving portion 20 and/or ground affixing fasteners, coupling the ladder 18 to the stabilized base plate 14 with the ladder retaining members 78 provides stability to the ladder 18.

The ladder retaining members 78 can be adapted to couple with a lower portion of the ladder 18 and the ladder retainer attachment portions 76 using means known to a person of skill in the art. For example, the ladder retaining members 78 can simply wrap around either the lower rung 21 of the ladder 18 and/or apertures of the ladder retainer attachment portions 76. The ladder retaining members 78 can also include end fittings, such as the hook 80, to facilitate attachment to either the ladder 18 or the base plate 14. The end fittings can also include, for example, S-hooks, snap hooks, bolt/anchor plates, J-hooks, flat hooks, and other variations known to a person skilled in the art.

The ladder retaining members 78 is preferably comprised of webbing (i.e. a strong fabric woven as a flat strip or tube of varying width and fibres), but can also be comprised of wire or rope. Webbing is typically comprised of synthetic fiber, such as nylon or polyester, for example. Commercially available tie downs can be used to implement the ladder retaining members 78 and can further include end fittings or a tensioning mechanism.

The ladder retaining members 78 can simply wrap around a lower rung 21 of the ladder 18 as illustrated in FIG. 7 to secure the ladder 18 to the base plate 14. In the embodiment with the ladder retainer attachment portions 76 outside the ladder feet 19, the ladder retaining members 78 can wrap around the legs of ladder 18 or otherwise attach to the legs of the ladder 18. In other embodiments the ladder retaining member 78 can include the rung retainer 42 that has a lip 48 that wraps at least in part around the lower rung 21. In other embodiments the ladder retaining members 78 can have hooks to attach to the ladder 18 (e.g. the lower rung 21, legs or an attachment mechanism coupled to the ladder) similar to hooks 80 that couple the ladder retaining members 78 to the ladder retainer attachment portions 76.

The ladder retaining members 78 can also include a tensioning mechanism 82 that applies tension to the ladder retaining members 78 to hold the ladder 18 to the base plate 14 of the ladder stabilizer. Commercially available tie downs can be used that include a tensioning mechanism, such as a ratchet or spring clamp. Other tensioning mechanisms used with webbing or tie downs can also be used, including, for example, cam fasteners, over-center fasteners, ratchet fasteners or buckles.

Cam fasteners use a cam to push down on the webbing that is passed through the cam and prevent the webbing from slipping back through the fastener. The edge of the cam lever that faces the webbing is usually knurled to provide a firmer grip on the webbing. Tension is added by pulling the excess webbing through the fastener until the necessary tension is achieved and then releasing the cam lever to lock the webbing in place.

Over-center fasteners require a slightly more complex threading procedure to start the webbing through the fastener. When the over-center fastener is “open” you can feed the excess webbing through the fastener. When all of the slack is removed, the act of “closing” the fastener will add tension to the webbing and hold that tension tightly in place.

Ratchet fasteners use a ratcheting mechanism to take up the slack in the webbing and tension the webbing to the necessary level. The ratcheting mechanism functions similarly to a socket wrench to open and close the fastener repeatedly to pull the webbing through the fastener. Releasing the tension is a simple matter of depressing the release lever and pulling the webbing back through the fastener.

Buckles can also be used to apply tension to the ladder retaining member 78. The two most common are threaded buckles and snap buckles, but other type of buckles can be used. Buckles work like those found on backpacks and duffel bags to allow fastening of the strap.

In other embodiments, the leg retainer can include one or more sliding clasps that are coupled to the base plate 14. The sliding clasps would engage a portion of one or more of the ladder feet 19. A tensioning mechanism can be included with the one or more sliding clasps to lock the sliding clasp in place to fixedly couple one or more of the ladder feet 19. The sliding clasps can be configured to engage one or both ladder legs and can include an inner and outer member to engage either side of the ladder foot working in combination or a single sliding clasp that engages on a single side of the ladder foot 19. In some embodiments, the sliding clasp and tensioning mechanism can be similar to those used in ski bindings where the ladder feet 19 are pressed into the sliding clasp to engage the locking or tensioning or tension mechanism.

When introducing elements disclosed herein, the articles “a”, “an”, “the”, and “said” are intended to mean that there are one or more of the elements. The terms “comprising”, “having”, “including” are intended to be open-ended and mean that there may be additional elements other than the listed elements.

With respect to the terms “coupled”, “coupling” or “attached”, these terms are understood to encompass integral with or connected thereto.

The above disclosure generally describes the present invention. Changes in form and substitution of equivalents are contemplated as circumstances may suggest or render expedient. Although specific terms have been employed herein, such terms are intended in a descriptive sense and not for purposes of limitation.

We claim:

1-22. (canceled)

23. A ladder stabilizer comprising a base plate to engage a lower portion of the ladder, wherein a bottom surface of the tire-receiving portion has a base plate-engaging mechanism to fixedly couple the tire receiving portion to the base plate and at least one tire-receiving portion at an end portion of the base plate.

24. The ladder stabilizer of claim 23, wherein the tire-receiving portion is moveable between a first position at the end portion and a second position at an opposing end portion of the base plate.

25. The ladder stabilizer of claim 23, wherein the base plate-engaging mechanism is one or more protrusions that couples with an aperture defined in a top surface at any one of the end portions of the base plate.

26. The ladder stabilizer of claim 23, wherein the base plate has at least one ladder retainer attachment portion.

27. The ladder stabilizer of claim 26, wherein the base plate has at least two upstanding portions forming a ladder-foot receiving channel, and wherein the ladder retainer attachment portion is defined as an aperture in any one of the at least two upstanding portions.

28. The ladder stabilizer of claim 26 further comprising a ladder retaining member for coupling the ladder to the ladder retainer attachment portion of the base plate.

29. The ladder stabilizer of claim 28, wherein the ladder retaining member includes a tensioning mechanism.

30. The ladder stabilizer of claim 23, wherein said at least one tire-receiving portion comprises a formation on said base plate for positioning the tire.

31. The ladder stabilizer of claim 30, wherein said formation is a well.

32. A ladder stabilizer comprising a base plate with at least one tire-receiving portion and at least one leg retainer mounted thereon for engaging a ladder leg wherein each leg retainer defines a channel for receiving the ladder leg.

33. The ladder stabilizer of claim 32, comprising two leg retainers.

34. The ladder stabilizer of claim 33, wherein each leg retainer is pivotally mounted on the base plate.

35. The ladder stabilizer of claim 34, further comprising a shaft on said base plate, each leg retainer being pivotally mounted on the shaft.

36. The ladder stabilizer of claim 35, wherein each leg retainer is independently pivotable about the shaft.

37. The ladder stabilizer of claim 36, wherein each leg retainer is laterally slidable along the base plate.

38. The ladder stabilizer of claim 35, wherein each leg retainer is independently pivotable about and slidable along the shaft.

39. The ladder stabilizer of claim 32, wherein each leg retainer is adjustable to alter a dimension of said channel.

40. The ladder stabilizer of claim 23, further comprising at least one ground-securing element to secure said base plate to a support surface.
